(19) United States
(12) Patent Application Publication
(10) Pub. No.: US 2026/0141574 A1
(43) Pub. Date: May 21, 2026

(54) VIDEO PROCESSING METHOD, VIDEO PROCESSING DEVICE, AND CAMERA DRIVER PROGRAM THEREFOR

(71) Applicant: ASUSTEK COMPUTER INC., TAIPEI (TW)

(72) Inventors: Kuo-Peng YAO, TAIPEI (TW); Jen-Chiu CHIANG, TAIPEI (TW)

(21) Appl. No.: 19/061,245

(22) Filed: Feb. 24, 2025

(30) Foreign Application Priority Data
Nov. 21, 2024 (TW) 113144891

(51) Int. Cl. G06T 11/00; G06T 3/40; H04N 23/60

(52) U.S. Cl. CPC G06T 11/00; G06T 3/40; H04N 23/60

(57) ABSTRACT

A video processing method for a video conference is provided. The video processing method is adapted to an electronic device. The electronic device has a camera, which has a hardware shutter, and is installed with a camera driver program and a conference program. The video processing method comprises the following steps. Firstly, the camera driver program is used to retrieve a business card image. Then, the camera driver program is used to access a streaming video. Afterward, the camera driver program is used to add the business card image in the streaming video to generate a processed streaming video. Then, the processed streaming video is shown through the conference program. A video processing device and a camera driver program are also provided.

### CROSS-REFERENCE TO RELATED APPLICATION

This application claims the priority benefit of Taiwan Application Serial No. 113144891, filed on Nov. 21, 2024. The entirety of the above-mentioned patent application is hereby incorporated by reference herein and made a part of specification.

### BACKGROUND OF THE INVENTION

### FIELD OF THE INVENTION

The disclosure relates to video processing technologies, and in particular, to a video processing method and a video processing device for a video conference, and a camera driver program.

### Description of the Related Art

As network technologies develop, a market size of a video conference system increases year by year.

To facilitate distinguishing conference participants during a video conference, a current video conference system marks login names of the conference participants next to images of the conference participants. However, this marking manner does not enable other conference participants to intuitively and clearly learn detailed information of the conference participants.

### BRIEF SUMMARY OF THE INVENTION

The disclosure provides a video processing method for a video conference, adapted to an electronic device. The electronic device has a camera, a camera driver program and a conference program are installed on the electronic device, and the camera has a hardware shutter. The video processing method includes: obtaining a business card image by using the camera driver program; driving the camera by using the camera driver program, to obtain a streaming video; adding the business card image to the streaming video by using the camera driver program, to generate a processed streaming video; and presenting the processed streaming video by using the conference program.

The disclosure provides a video processing device for a video conference, adapted to an electronic device. The electronic device has a camera, a camera driver program and a conference program are installed on the electronic device, and the camera has a hardware shutter. The video processing device includes a business card setting unit and a video processing unit. The business card setting unit is suitable for generating a business card image. The video processing unit is suitable for executing the camera driver program to obtain the business card image, driving the camera to obtain a streaming video, adding the business card image to the streaming video, to generate a processed streaming video, and presenting the processed streaming video by using the conference program.

The disclosure provides a camera driver program, adapted to an electronic device. The electronic device has a camera, a conference program is installed on the electronic device, and the camera has a hardware shutter that performs the following steps after being loaded into the camera driver program through a computer. First, a business card image is obtained. Second, the camera is driven to obtain a streaming video. Next, the business card image is added to the streaming video to generate a processed streaming video. Then, the processed streaming video is presented by using the conference program.

According to the video processing method, the video processing device, and the camera driver program that are provided in the disclosure, a business card image of a conference participant is presented in a streaming video of a video conference. In this case, another conference participant not only identifies an identity of the conference participant, but also intuitively and clearly learns detailed information of the conference participant, thereby facilitating communication between the conference participants.

### BRIEF DESCRIPTION OF THE DRAWINGS

FIG. 1 is a schematic block diagram showing a video processing device for a video conference according to an embodiment of the disclosure;

FIG. 2 is a schematic diagram showing a conference participant according to an embodiment of the disclosure;

FIG. 3 is a schematic block diagram showing a video processing device for a video conference according to another embodiment of the disclosure;

FIG. 4 is a schematic diagram showing an image of a conference participant when a hardware shutter is in a closed state according to an embodiment of the disclosure;

FIG. 5 is a flowchart showing a video processing method for a video conference according to a first embodiment of the disclosure;

FIG. 6 is a flowchart showing a video processing method for a video conference according to a second embodiment of the disclosure;

FIG. 7 is a flowchart showing a video processing method for a video conference according to a third embodiment of the disclosure; and

FIG. 8 is a flowchart showing a video processing method for a video conference according to a fourth embodiment of the disclosure.

### DETAILED DESCRIPTION OF THE EMBODIMENTS

The following describes specific implementations of the disclosure in more detail with reference to the schematic diagrams. The advantages and features of the disclosure become more apparent based on the following descriptions and the scope of the claims. It should be noted that all the drawings are in very simplified form, in inexact proportions, and only used to conveniently and clearly assist in describing the embodiments of the disclosure.

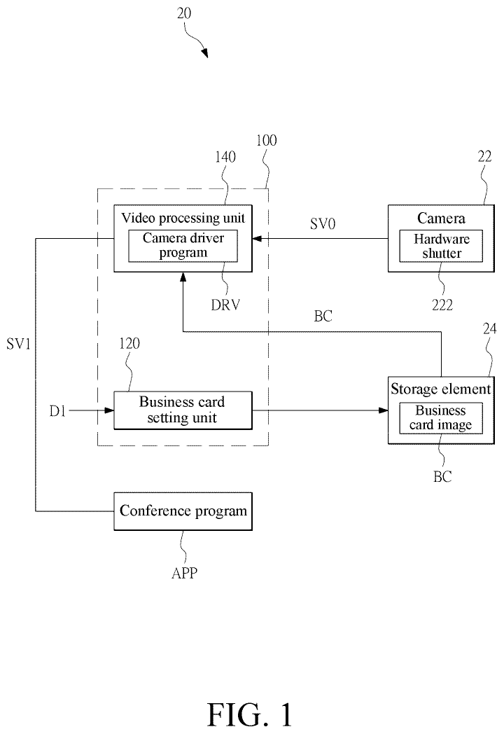

FIG. 1 is a schematic block diagram showing a video processing device 100 for a video conference according to an embodiment of the disclosure.

The video processing device 100 is adapted to an electronic device 20. The electronic device 20 has a camera 22 and a storage element 24, a camera driver program DRV and a conference program APP are installed, and the camera 22 has a hardware shutter 222. In an embodiment, the electronic device 20 may be an electronic device 20 on which the camera 22 is installed and video conferencing is performed, such as a notebook computer, a tablet computer, or a smartphone.

As shown in the figure, the video processing device 100 includes a business card setting unit 120 and a video processing unit 140.

The business card setting unit 120 is suitable for generating a business card image BC stored in the storage element 24. In an embodiment, the business card setting unit 120 may be an application program that generates a business card image based on user information D1.

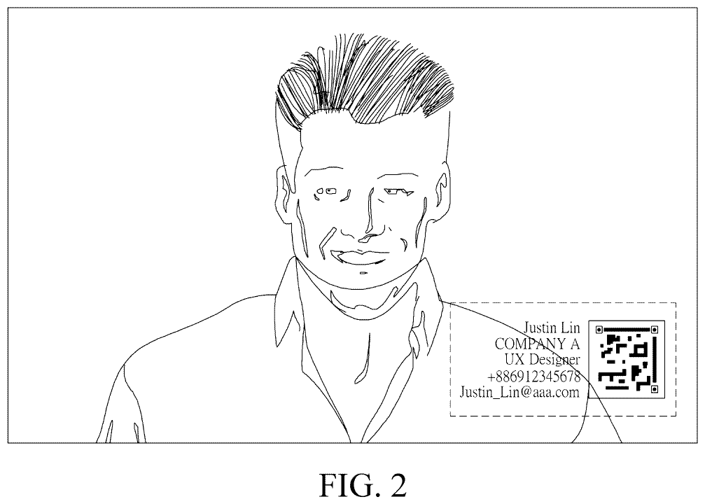

The video processing unit 140 is suitable for executing the camera driver program DRV to obtain the business card image BC, driving the camera 22 to obtain a streaming video SV0, adding the business card image BC to the streaming video SV0, to generate a processed streaming video SV1, and transmitting the processed streaming video SV1 to the conference program APP for presentation. In an embodiment, as shown in FIG. 2, FIG. 2 is a schematic diagram showing an image of a conference participant according to an embodiment of the disclosure. As shown in the figure, the business card image BC is a watermark image, and is superimposed on the streaming video SV0 obtained by driving the camera 22, to generate the processed streaming video SV1. The business card image BC not only presents a job title, a name, a contact call, and a mailbox of the conference participant, but also provides a QR code, to facilitate obtaining information by another conference participant.

In an embodiment, as shown in the figure, the video processing device 100 further has a control interface, suitable for obtaining a display control instruction. The video processing unit 140 obtains the display control instruction through the control interface, and selectively adds the business card image BC to the streaming video SV0 based on the display control instruction. In this case, a user adds or removes the business card image BC from the streaming video SV0 based on a requirement of the user.

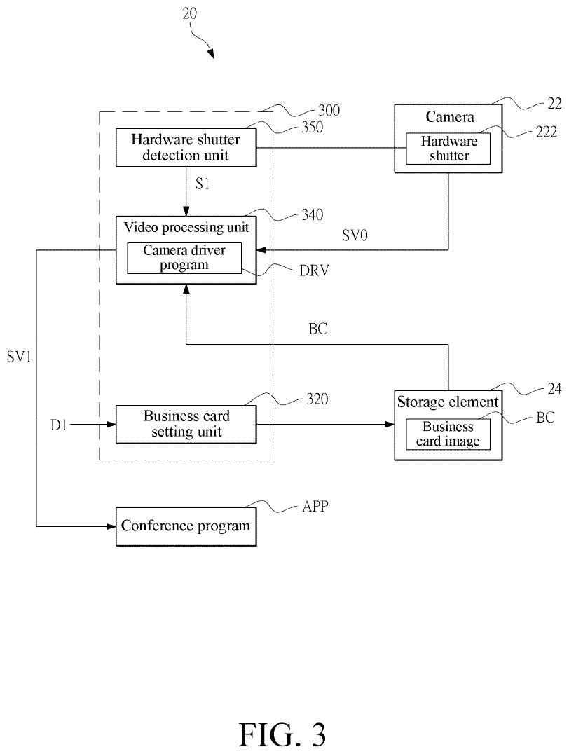

FIG. 3 is a schematic block diagram showing a video processing device 300 for a video conference according to another embodiment of the disclosure.

As shown in the figure, in addition to a business card setting unit 320 and a video processing unit 340, the video processing device 300 in this embodiment further includes a hardware shutter detection unit 350. The hardware shutter detection unit 350 is suitable for detecting a shutter state of a hardware shutter 222 to generate a detection signal S1. The video processing unit 340 selectively adds a business card image BC to a streaming video SV0 based on the detection signal S1. That is, the business card image BC is added to or removed from the streaming video SV0 based on the detection signal S1. The business card setting unit 320 in this embodiment is the same as that in the embodiment in FIG. 1, and details are not described herein again.

In an embodiment, the video processing unit 340 is suitable for changing, based on the detection signal S1, a size of the business card image BC added to the streaming video SV0. In an embodiment, the video processing unit 340 adds the business card image BC to the streaming video SV0 in an original size or a full screen size based on the detection signal S1.

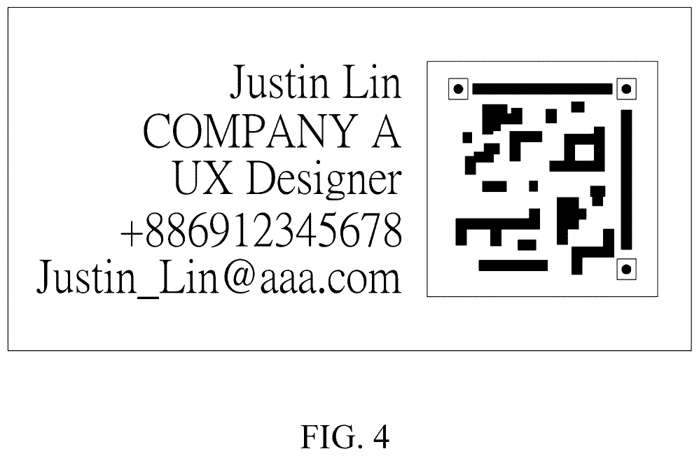

Specifically, as shown in FIG. 4, FIG. 4 is a schematic diagram showing an image of a conference participant when a hardware shutter 222 is in a closed state according to an embodiment of the disclosure. As shown in the figure, when the hardware shutter 222 is in the closed state, a business card image BC is added to a streaming video SV0 in a full screen size, to generate a processed streaming video SV1, to facilitate checking detailed information of a user by another conference participant.

In contrast, when the hardware shutter 222 is in an open state, referring to FIG. 2 together, the business card image BC is added to the streaming video SV0 in an original size, to generate the processed streaming video SV1, to avoid that the business card image BC obscures an image of the user.

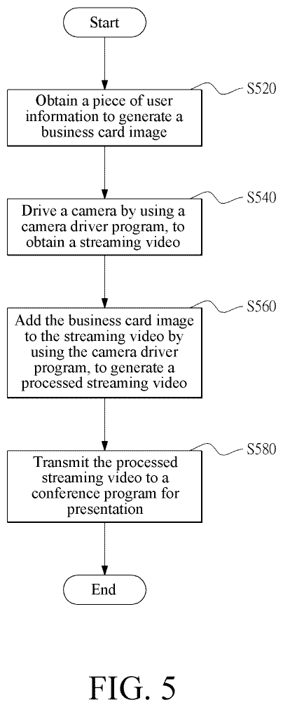

FIG. 5 is a flowchart showing a video processing method for a video conference according to a first embodiment of the disclosure. The video processing method is adapted to an electronic device 20. The electronic device 20 has a camera 22, a camera driver program DRV and a conference program APP are installed, and the camera 22 has a hardware shutter 222. The video processing method includes the following steps.

First, as described in step S510, a piece of user information D1 is obtained to generate a business card image BC. The business card image BC is stored in a storage element 24.

Subsequently, as described in step S520, the business card image BC is obtained by using the camera driver program DRV.

Then, as described in step S540, the camera 22 is driven by using the camera driver program DRV, to obtain a streaming video SV0.

Next, as described in step S560, the business card image BC is added to the streaming video SV0 by using the camera driver program DRV, to generate a processed streaming video SV1.

Then, as described in step S580, the processed streaming video SV1 is presented by using the conference program APP.

According to the foregoing video processing method, even if the installed conference program APP does not provide a business card display function, a user also directly implements the business card display function by using the camera driver program DRV without installing an additional application program, and also avoids a problem that conference program execution may be interfered with because another application program is installed in an operating system.

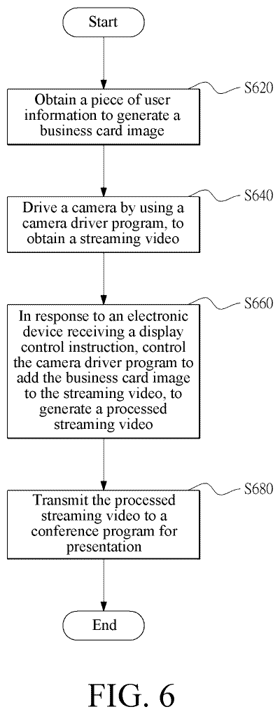

FIG. 6 is a flowchart showing a video processing method for a video conference according to a second embodiment of the disclosure. The video processing method is applied to the video conferencing devices 100 and 300 shown in FIG. 1 and FIG. 3, and is adapted to an electronic device 20. The electronic device 20 has a camera 22, a camera driver program DRV and a conference program APP are installed, and the camera 22 has a hardware shutter 222. The video processing method includes the following steps.

First, as described in step S610, a piece of user information D1 is obtained to generate a business card image BC. The business card image BC is stored in a storage element 24.

Subsequently, as described in step S620, the business card image BC is obtained by using the camera driver program DRV.

Then, as described in step S640, the camera 22 is driven by using the camera driver program DRV, to obtain a streaming video SV0.

Next, as described in step S660, in response to the electronic device 20 receiving a display control instruction, the camera driver program DRV is controlled to add the business card image BC to the streaming video SV0, to generate a processed streaming video SV1.

Specifically, in a process in which a user participates in a conference, a user enters the display control instruction at any time through an operation interface of the electronic device 20, to control the video conferencing devices 100 and 300 to add the business card image BC to the streaming video SV0, to remove the business card image BC, or to modify a presentation manner of the business card image BC, such as a size or transparency of the business card image BC. In an embodiment, the operation interface is another window independent of the conference program APP.

Then, as described in step S680, the processed streaming video SV1 is presented by using the conference program APP.

According to the foregoing video processing method, the user controls the presentation manner of the business card image at any time through the operation interface, to meet a requirement thereof.

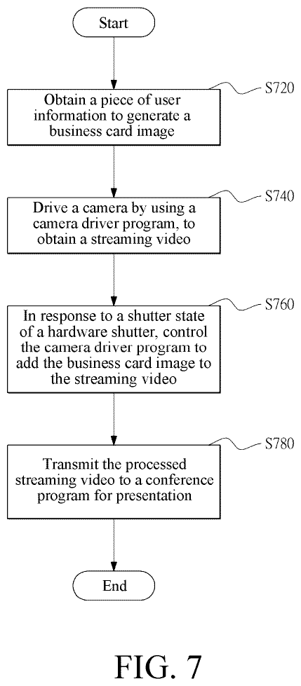

FIG. 7 is a flowchart showing a video processing method for a video conference according to a third embodiment of the disclosure. The video processing method is applied to the video conferencing devices 100 and 300 shown in FIG. 1 and FIG. 3, and is adapted to an electronic device 20. The electronic device 20 has a camera 22, a camera driver program DRV and a conference program APP are installed, and the camera 22 has a hardware shutter 222. The video processing method includes the following steps.

First, as described in step S710, a piece of user information D1 is obtained to generate a business card image BC stored in a storage element 24.

Subsequently, as described in step S720, the business card image BC is obtained by using the camera driver program DRV.

Then, as described in step S740, the camera 22 is driven by using the camera driver program DRV, to obtain a streaming video SV0.

Next, as described in step S760, in response to a shutter state of the hardware shutter 222, the camera driver program DRV is controlled to add the business card image BC to the streaming video SV0.

Specifically, in step S760, whether to add the business card image BC to the streaming video SV0 or which business card image BC to be added to the streaming video SV0 is determined by obtaining a detection signal S1 corresponding to the shutter state of the hardware shutter 222.

For example, if the detected signal S1 indicates that the hardware shutter 222 is in a closed state, in step S760, the streaming video SV0 is directly used as a processed streaming video SV1; or in contrast, if the detection signal S1 indicates that the hardware shutter 222 is in the open state, in step S760, the business card image BC is added to the streaming video SV0 to generate a processed streaming video SV1.

In another embodiment, two different business card images are generated based on the different states of the hardware shutter 222. If the detection signal S1 indicates that the hardware shutter 222 is in the closed state, in step S760, a business card image BC adapted to the hardware shutter 222 in the closed state is added to the streaming video SV0 to generate the processed streaming video SV1. In contrast, if the detection signal S1 indicates that the hardware shutter 222 is in the open state, in step S760, a business card image BC adapted to the hardware shutter 222 in the open state is added to the streaming video SV0 to generate the processed streaming video SV1. For example, for an application environment of the hardware shutter 222 in the closed state, a personal photo of a user is additionally added to the business card image BC.

Then, as described in step S780, the processed streaming video SV1 is presented by using the conference program APP.

In the foregoing video processing method, an appropriate presentation manner is automatically selected to present the business card image BC based on the shutter state of the hardware shutter 222. In this case, presentation of the business card image BC is stopped when there is no external image in the streaming video SV0, to avoid interference to a conference. In addition, when the hardware shutter 222 is opened and the streaming video SV0 has an external image, the business card image BC is added to the streaming video SV0 in an original size, to generate the processed streaming video SV1, to help provide detailed information of the user to another conference participant.

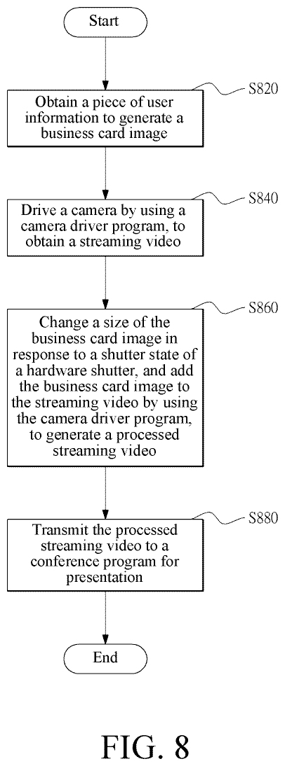

FIG. 8 is a flowchart showing a video processing method for a video conference according to a fourth embodiment of the disclosure. The video processing method is applied to the video conferencing devices 100 and 300 shown in FIG. 1 and FIG. 3, and is adapted to an electronic device 20. The electronic device 20 has a camera 22, a camera driver program DRV and a conference program APP are installed, and the camera 22 has a hardware shutter 222. The video processing method includes the following steps.

First, as described in step S810, a piece of user information D1 is obtained to generate a business card image BC stored in a storage element 24.

As described in step S820, the business card image BC is obtained by using the camera driver program DRV.

Then, as described in step S840, the camera 22 is driven by using the camera driver program DRV, to obtain a streaming video SV0.

Next, as described in step S860, a size of the business card image BC is changed in response to a shutter state of the hardware shutter 222, and the business card image BC is added to the streaming video SV0 by using the camera driver program DRV, to generate a processed streaming video SV1.

In an embodiment, in the foregoing step, in response to the shutter state of the hardware shutter 222, the camera driver program DRV is controlled to add the business card image BC to the streaming video SV0 in an original size or a full screen size.

Specifically, in step S860, the shutter state of the hardware shutter is determined by obtaining a detection signal S1 corresponding to the shutter state of the hardware shutter 222. If the detection signal S1 indicates that the hardware shutter 222 is in a closed state, in step S860, the business card image BC is added to the streaming video SV0 in the full screen size, to generate the processed streaming video SV1; or in contrast, if the detection signal S1 indicates that the hardware shutter 222 is in the open state, the business card image BC is added to the streaming video SV0 in the original size, to generate the processed streaming video SV1.

Then, as described in step S880, the processed streaming video SV1 is presented by using the conference program APP.

In the foregoing video processing method, an appropriate presentation manner is automatically selected to present the business card image BC based on the shutter state of the hardware shutter 222. In this case, when there is no external image in the streaming video SV0, a detailed or large-sized business card image BC is presented, to facilitate checking detailed information of a user by another conference participant. In addition, when the streaming video SV0 has an external image, the business card image BC is added to the streaming video SV0 in the original size, to generate the processed streaming video SV1, to avoid that the business card image BC obscures an image of the user.

The disclosure further provides a camera driver program DRV, adapted to an electronic device 20. The electronic device 20 has a camera 22, a conference program APP is installed, and the camera 22 has a hardware shutter 222 that performs the following steps after being loaded into the camera driver program DRV through a computer. First, a business card image BC is obtained. Subsequently, the camera 22 is driven to obtain a streaming video SV0. Next, the business card image BC is added to the streaming video SV0 to generate a processed streaming video SV1. Then, the processed streaming video SV1 is transmitted to the conference program APP for presentation.

According to the video processing method, the video processing devices 100 and 300, and the camera driver program DRV that are provided in the disclosure, the business card image BC of the conference participant is presented in the streaming video SV0 of the video conference. In this case, another conference participant not only identifies an identity of the conference participant, but also intuitively and clearly learns detailed information of the conference participant, thereby facilitating communication between the conference participants.

The foregoing descriptions are merely preferred embodiments of the disclosure, and are not intended to limit the disclosure. A person skilled in the art can make equivalent replacements, modifications, or other changes in any form to the technical means and technical content disclosed in the disclosure without departing from the scope of the technical means of the disclosure, which shall fall within the protection scope of the disclosure without departing from the content of the technical means of the disclosure.

What is claimed is:

1. A video processing method for a video conference, adapted to an electronic device, wherein the electronic device has a camera, a camera driver program and a conference program are installed on the electronic device, the camera has a hardware shutter, and the video processing method comprises:
obtaining a business card image by using the camera driver program;
driving the camera by using the camera driver program, to obtain a streaming video;
adding the business card image to the streaming video by using the camera driver program, to generate a processed streaming video; and
presenting the processed streaming video by using the conference program.

2. The video processing method according to claim 1, wherein the step of adding the business card image to the streaming video by using the camera driver program, to generate the processed streaming video comprises:
controlling, in response to the electronic device receiving a display control instruction, the camera driver program to add the business card image to the streaming video, to generate the processed streaming video.

3. The video processing method according to claim 1, wherein the step of adding the business card image to the streaming video by using the camera driver program, to generate the processed streaming video comprises:
controlling, in response to a shutter state of the hardware shutter, the camera driver program to add the business card image to the streaming video.

4. The video processing method according to claim 1, before the step of adding the business card image to the streaming video by using the camera driver program, to generate a processed streaming video, further comprising:
changing a size of the business card image in response to a shutter state of the hardware shutter.

5. The video processing method according to claim 4, wherein the step of changing a size of the business card image in response to the shutter state of the hardware shutter comprises:
controlling, in response to the shutter state of the hardware shutter, the camera driver program to add the business card image to the streaming video in an original size or a full screen size.

6. The video processing method according to claim 1, wherein the electronic device comprises a storage element, and the video processing method further comprises:
obtaining a piece of user information to generate the business card image stored in the storage element.

7. The video processing method according to claim 6, wherein the step of adding the business card image to the streaming video by using the camera driver program, to generate a processed streaming video comprises:
obtaining a display control instruction corresponding to the business card image; and
adding the business card image to the streaming video based on the display control instruction by using the camera driver program.

8. The video processing method according to claim 1, further comprising:
obtaining a detection signal corresponding to a shutter state of the hardware shutter.

9. The video processing method according to claim 8, wherein the step of adding the business card image to the streaming video by using the camera driver program, to generate a processed streaming video comprises:
adding the business card image to the streaming video based on the detection signal by using the camera driver program.

10. The video processing method according to claim 8, wherein the step of adding the business card image to the streaming video by using the camera driver program, to generate a processed streaming video comprises:
adding the business card image to the streaming video in an original size or a full screen size based on the detection signal by using the camera driver program.

11. The video processing method according to claim 1, wherein the business card image is a watermark image.

12. A video processing device for a video conference, adapted to an electronic device, wherein the electronic device has a camera, a camera driver program and a conference program are installed on the electronic device, the camera has a hardware shutter, and the video processing device comprises:
a business card setting unit, suitable for generating a business card image; and
a video processing unit, suitable for executing the camera driver program to:
obtain the business card image;
drive the camera to obtain a streaming video; and
add the business card image to the streaming video, to generate a processed streaming video, and present the processed streaming video by using the conference program.

13. The video processing device according to claim 12, further comprising a control interface, suitable for obtaining a display control instruction, wherein the video processing unit adds the business card image to the streaming video based on the display control instruction.

14. The video processing device according to claim 12, further comprising a hardware shutter detection unit, suitable for detecting a shutter state of the hardware shutter, to generate a detection signal, wherein the video processing unit adds the business card image to the streaming video based on the detection signal.

15. The video processing device according to claim 12, further comprising a hardware shutter detection unit, suitable for detecting a shutter state of the hardware shutter to generate a detection signal, wherein the video processing unit is suitable for changing, based on the detection signal, a size of the business card image added to the streaming video.

16. The video processing device according to claim 15, wherein the video processing unit adds the business card image to the streaming video in an original size or a full screen size based on the detection signal.

17. A camera driver program, adapted to an electronic device, wherein the electronic device has a camera, a conference program is installed on the electronic device, and the camera has a hardware shutter that performs the following steps after being loaded into the camera driver program through a computer:
obtaining a business card image;
driving the camera to obtain a streaming video;
adding the business card image to the streaming video to generate a processed streaming video; and
presenting the processed streaming video by using the conference program.
